(19) United States
(12) Patent Application Publication
(10) Pub. No.: US 2019/0195402 A1
(43) Pub. Date: Jun. 27, 2019

(54) CONNECTION DEVICE, IN PARTICULAR FOR THE REALIZATION OF A ROTARY CONNECTION FOR A CONNECTION COMPONENT

(71) Applicant: EISELE PNEUMATICS GMBH & CO. KG, Waiblingen (DE)

(72) Inventor: Franz Markus OESTREICH, Waiblingen (DE)

(73) Assignee: Eisele Pneumatics GmbH & Co. KG, Waiblingen (DE)

(21) Appl. No.: 16/310,890

(22) PCT Filed: May 30, 2017
(86) PCT No.: PCT/EP2017/000631

§ 371 Date: Dec. 18, 2018

(30) Foreign Application Priority Data
Jun. 23, 2016 (DE) 10 2016 007 917.7

(51) Int. Cl. F16L 27/08; F16C 19/06

(52) U.S. Cl. CPC F16L 27/0828; F16L 27/0812; F16C 19/06

(57) ABSTRACT

A connection device, in particular for the realization of a rotary connection for a connection component (71, 89), with a housing (1), which comprises a connection point (7) for a fluid conveying conduit, such as a pneumatic line, and a bearing arrangement (31), by means of which an axial or shaft-type connecting part (24) is mounted so as to be rotatable relative to the housing (1), said connecting part comprising an additional connection point (27) for the connection component (71, 89), is characterized in that the bearing arrangement (31) comprises at least one rolling bearing (35), which is in contact with the housing (1) via the outside of its outer race (55) and with the rotatable connecting part (24) via the outside of its inner race (49).

The invention relates to a connection device, in particular for implementing a rotary connection for a connection component, having a housing, which has a connection point for a fluid-conveying line, such as a pneumatic line, and a bearing arrangement, by means of which a hollow shaft or axis-shaped connector part is mounted so as to be rotatable relative to the housing and which forms a further connection point for the relevant further connection component.

Such devices are used, for example, for connecting connection components in the form of two hose lines or for connecting a hose line to a fixed line connection, wherein bending or torsional loads possibly occurring on the line components forming the line sections are reduced or avoided due to the rotatability of the connection points provided by the bearing arrangement. Different media, such as gases or liquids, can be routed through the line sections.

A connection device of the type mentioned above is known from DE 20 2009 005 674 U1. In this device the bearing arrangement is formed by an inner wall section of a hollow shaft-like connector part forming a slide bearing, which connector part comprises a housing part formed by a rotary body. With this arrangement, no sufficient stability of the connection area between the housing and the rotatable connector part, in particular no operational reliability for longitudinal forces acting between the connector parts, can be achieved because of the axial displacement permitted by the slide bearing section.

Based on this prior art, the invention addresses the problem of providing a generic connection device, which is characterized by a high mechanical stability in a compact and media-tight design.

According to the invention, this problem is solved by a connection device having the features of claim 1 in its entirety.

According to the characterizing part of claim 1, a significant feature of the invention is that the bearing arrangement comprises at least one roller bearing, the outside of the outer race of which is in contact with the housing and the outside of the inner race of which bears on the rotatable connector part. With this arrangement, where the inner race is secured on the rotatable connector part, which inner race is preferably secured to the rotatable connector part by a pressing process, such that it cannot be displaced axially, a rotary bearing between the housing and connector part can be formed, which bearing is particularly robust with respect to axial forces and bending forces.

In particularly advantageous exemplary embodiments, the bearing arrangement has, in addition to the roller bearing, a slide bearing, whose inner peripheral side encompasses the rotatable connector part, the end face of which rests against a press-fit ring of the housing, which encompasses the end of the connector part while maintaining radial and axial spacing, the slide bearing otherwise being mounted in a spacer ring. Two axially spaced bearings result in a particularly high bending strength of the bearing, wherein the slide bearing held in a spacer ring is secured in the axial direction by the frontal contact against a press-fit ring firmly attached to the housing.

A ball bearing can advantageously be provided as a roller bearing.

In advantageous exemplary embodiments, the spacer ring is radially sealed with the slide bearing facing the housing, in particular using an O-ring, and rests against a further seal in the axial direction, in particular in the form of a shaft seal, which encompasses the connector part and which has a contact surface for a spacer ring opposite the spacing ring, which engages with the outer race of the ball bearing at the end face thereof. This arrangement ensures a permanently high media tightness of the rotatable connection between the housing and connector part.

The arrangement can advantageously be made such that the spacing ring is angular viewed in cross-section, is in contact with the further seal in the area of one of its legs and has an axial spacing to a radially protruding bearing shoulder of the connector part opposite the seal, with which shoulder the connector part rests against the inner race of the roller bearing at the end face. In this way, the spacer ring is axially secured to the housing between the press-fit ring and the spacing ring.

In advantageous exemplary embodiments, the housing is formed of two parts, wherein one housing part has the bearing arrangement and the other housing part has the associated connection point and wherein the slide bearing of the press-fit ring rests at least partially against the distance ring in the area of the connection of the two housing parts.

Furthermore, the connection point of the rotatably mounted connector part, which is axially fixed in the housing by means of the bearing arrangement, can protrude from the housing with its associated connection point, wherein at the location of the penetration of the connector part, a ring opening is created between the housing and connector part, which serves for the penetration of parts of the connection component, the end faces of which rest against the inner race of the roller bearing and can be firmly attached to the connector part. This connection can advantageously be formed by a screw connection.

Advantageously, the arrangement may be made such that a further sealing ring is arranged between the press-fit ring and the further housing part and also on the further housing part in the area of the transition to the connection point for the fluid-conveying line.

According to claim 9, the subject matter of the invention also relates to a connection arrangement comprising at least one connection device according to one of the claims 1 to 8 and a connection component coupled thereto, which is connected to the connection device in a fluid-conveying manner and can move relative to the same by means of the bearing arrangement and the connector part mounted rotatably to that extent.

The housing structure of the connection component associated with this connection arrangement can have a linear or angular design and may have a quick coupling for supporting a further fluid-conveying line at its free end. Such a quick coupling may be designed in the known manner of a collet device actuatable by means of a clamping nut.

Below the invention is explained in detail with reference to exemplary embodiments shown in the drawing.

In the drawings:

FIG. 1 shows a perspective oblique view of an exemplary embodiment of the connection device according to the invention;

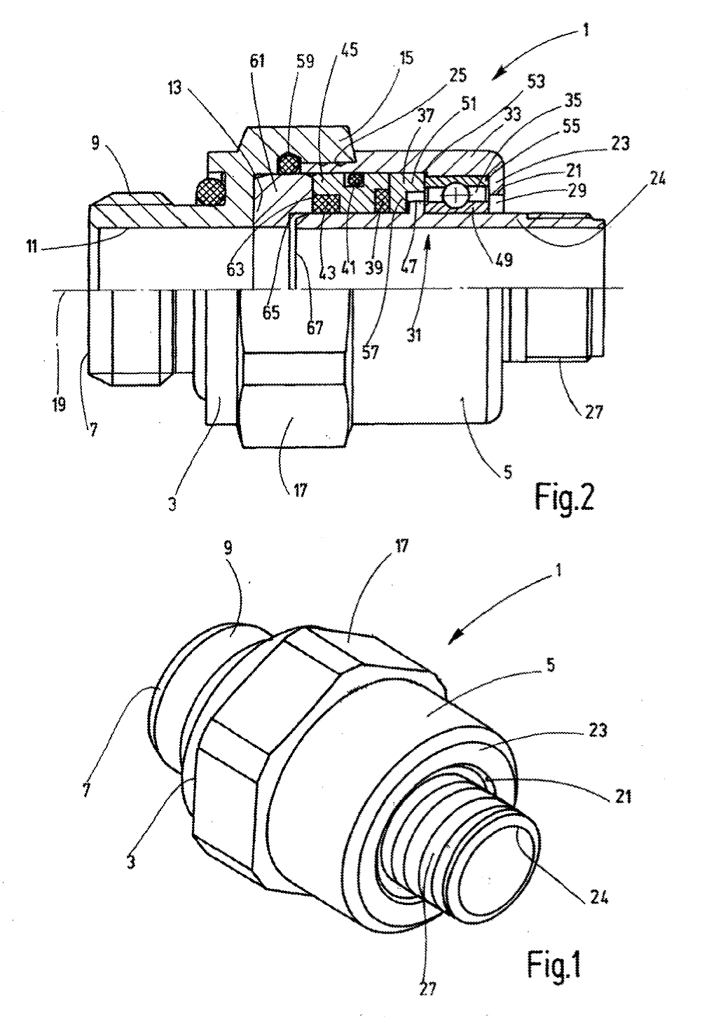

FIG. 2 shows a longitudinal section through one half of the exemplary embodiment;

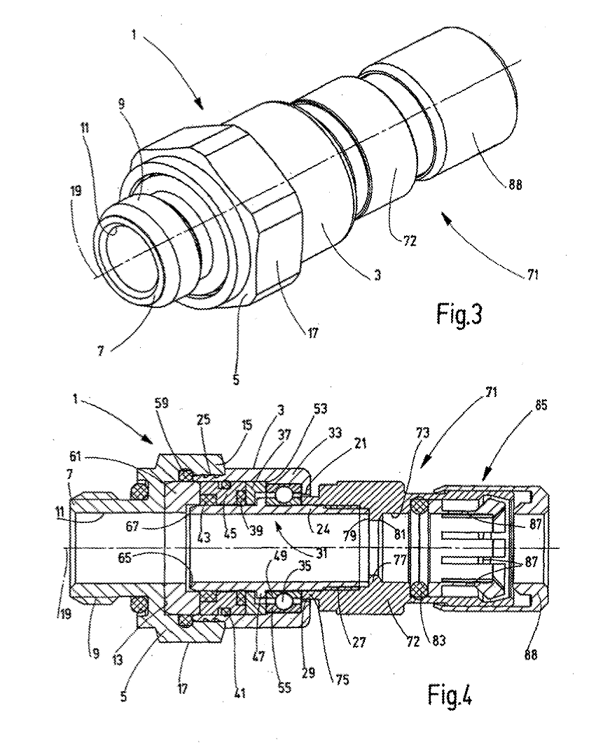

FIG. 3 shows a perspective oblique view of the exemplary embodiment of the connection device having a connection component of linear design connected thereto;

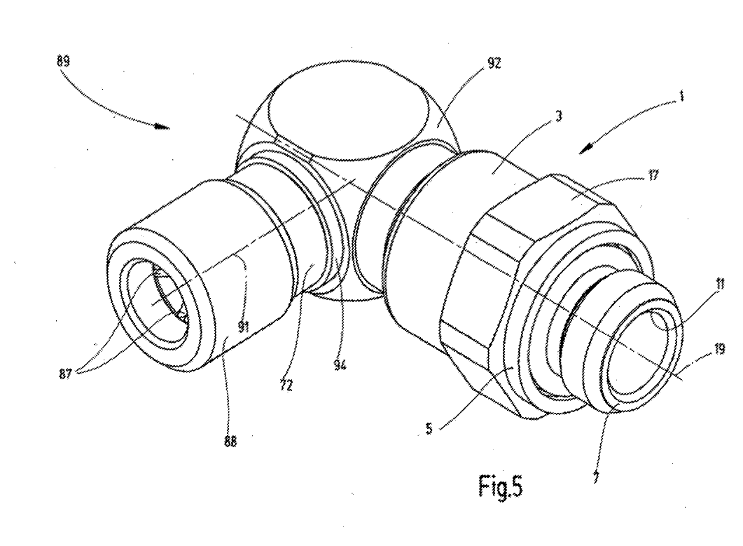

FIG. 4 shows a longitudinal section of the content shown in FIG. 3.

FIG. 5 shows a perspective oblique view of the exemplary embodiment of the connection device having a connection component of angular design connected thereto;

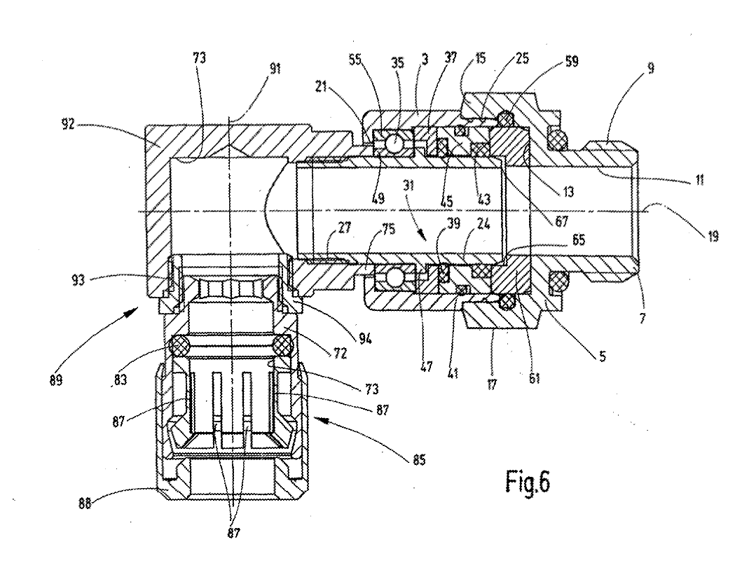

FIG. 6 shows a central angle section of the content shown in FIG. 5.

FIGS. 1 and 2 show an exemplary embodiment of the connection device according to the invention without the connection component connected thereto. The device has a housing 1, which consists of a metallic material, such as a bronze alloy, and is composed of two housing parts 3 and 5. A connection point 7 is formed at the end of the housing part 3 located on the left in FIGS. 1 and 2, which has a male thread 9 for a screw connection with a connection component not shown. The housing part 3 designed as a hollow body has a coaxial through hole 11, which opens to the outside at the connection point 7 and widens to approximately twice the diameter at approximately half the length of the housing part 3 forming a shoulder 13 in a radial plane. In the extended end part of the drilled hole 11, the end part 15 of the housing part 3, the outer circumference of which is extended, has a hexagon head 17.

The second housing part 5 has the shape of a circular cylindrical sleeve with a through-opening 21 concentric to the axis 19, which is located at a radially inward projecting end rim 23 of the tubular body of the housing part 5 at the end that is on the right in FIGS. 1 and 2. At the end area facing the first housing part 3, the housing part 5 is fixedly attached at 25 by pressing to the end part 15 of the first housing part 3, which extends over the end area. At the opposite end of the connection point 7, a second connection point is formed on a connector part in the form of a hollow shaft 24, which is rotatably mounted in the housing 1 and forms the fluid-conveying continuation of the drilled hole 11 of the first housing part 3. At the hollow shaft 24, the connection point for the connecting component, which again is not shown, is formed by a male thread 27, which is located on the end section of the hollow shaft 24 extending out of the housing part 5. The diameter of the drilled hole 21 of the housing part 5 provided for the passage of the hollow shaft 24 is dimensioned such that an annular gap 29 is formed between the hollow shaft 24 and the end rim 23 of the housing part 5.

The hollow shaft 24, which continues the flow path of the drilled hole 11 essentially without offset, is rotatably mounted in the second housing part 5 by means of a bearing arrangement 31, which is formed of a package of several components, which package is arranged on the end portion of the hollow shaft 24 mounted inside the housing part 5 and which extends between the hollow shaft 24 and the shell 33 of the housing part 5 substantially over the entire axial length of the latter. In sequence in FIG. 2 from right to left, the component package of the bearing arrangement 31 has a ball bearing 35, an angular spacing ring 37, a shaft seal 39, an O-ring 41 and a slide bearing 43, wherein the shaft seal 39, the O-ring 41 and the slide bearing 43 are mounted in a spacer ring 45. In approximately the central area of the longitudinal section of the hollow shaft 24 supporting the bearing arrangement 31, the hollow shaft has a radially outward projecting shoulder in the form of a ring 47 having a square cross-section. To manufacture the connection device, the procedure is such that the hollow shaft 24, including the package of the bearing arrangement 31, is installed in the housing part 5, before the housing 1 is closed by pressing the housing parts 3 and 5 together. To this end, first hollow shaft 24 and ball bearings 35 are pressed together such that the inner race 49 of the latter rests against the ring 47 of the hollow shaft 24. On the opposite side of the ring 47, the other components of the bearing arrangement 31 are preassembled on the hollow shaft 24, after which they are inserted together with the package of the bearing arrangement 31 from the open side of the housing part 5. In doing so, the radially outer leg 51 of the angular spacing ring 37 comes to rest against a shoulder 53 of the inside of the shell 33 and to rest against the outer race 55 of the ball bearing 35. In this position of the spacing ring 37 its radially inside leg is located at an axial distance from the radially protruding ring 47 of the hollow shaft 24. The spacer ring 45 with the associated shaft seal 39, the O-ring 41 and the slide bearing 43 rest against the spacing ring 37 at the side facing away from the ring 47.

Before closing the housing 1 by pressing the housing parts 3 and 5 together at 25, an O-ring 59 and a press-fit ring 61 are inserted on the inside of the end part 15, the side of the press-in ring facing away from the bearing arrangement 31 resting against the shoulder 13 of the housing part 3. On the side facing the bearing arrangement 31, the press-fit ring 61 has an annular surface 63 in a radial plane for contact on the spacer ring 45 and the slide bearing 43. A coaxial recess 65 adjoins the radially inner end of the annular surface 63, which recess forms a free space for the shaft end 67 of the hollow shaft 24, into which free space the shaft 24 extends without contact with the press-fit ring 61 when the housing 1 is closed. For this purpose, the press-fit ring 61 is fixed in position by the closing process of the housing 1. As shown in FIG. 2, when the housing 1 is closed, the bearing arrangement 31 is positively secured axially between the annular surface 63 of the press-fit ring 61 and the opening rim 23 of the housing part 5. The slide bearing 43, which is secured in the spacer ring 45 by the abutting annular surface 63 of the press-fit ring 61, is formed of a material having a high abrasion resistance and a low coefficient of friction, in the present example of a thermoplastic material, such as polyoxymethylene (POM), a material characterized by low coefficient of friction and dimensional stability. Due to the free gap between the radially protruding ring 47 of the shaft 24 and the spacing ring 37 and due to the recess 65 in the press-fit ring 61, into which the shaft end 67 extends without contact thereby forming a gap, the hollow shaft 24 can be easily rotated in the housing 1.

FIGS. 3 and 4 show the housing 1 in connection with a connection component 71, which is connected to the connection point formed by the free end of the hollow shaft 24 by screwing it onto the male thread 27. The connection component 71 has a hollow body 72 with a coaxial inner channel 73, which continues the fluid path of the hollow shaft 24 when connected. As FIG. 4 shows, the hollow body 72 at the end facing the housing 1 has a section 75 of reduced wall thickness, which, in the screwed-on state shown in FIG. 4, extends into the annular gap 29 at the passage opening 21 of the housing part 5 and rests against the inner race 49 of the ball bearing 35. The channel 73 has a constriction in the form of a radially inwardly protruding ring 77, which has a flat contact surface 79 on one side, which abuts the end of the hollow shaft 24 in the screwed-on state (FIG. 4). An inclined surface 81, against which the end of a conduit connected by means of the connection component 71, such as a hose line, rests, forms the opposite side of the ring 77, which surface extends through an O-ring 83. The connection component 71 has a quick coupling 85 for the attachment of such a hose, which quick coupling is formed by a collet device of conventional design in the example shown, which has a basket of flexible chuck levers 87, which can be actuated by a clamping sleeve 88 for the clamping operation.

FIGS. 5 and 6 show a modified example, in which an angular connection component 89 is connected at the connection point formed by the free end of the hollow shaft 24, which component continues the fluid connection in the direction of an axis 91, which runs at right angles to the axis 19 of the housing 1. The connection component 89 has a connection body 92, which, like the hollow body 72 of the connection component 71, has an inner channel 73 as a continuation of the fluid path of the hollow shaft 24. Like the hollow body 72, the connecting body 92 is screwed to the male thread 27 of the hollow shaft 24, wherein, as in the previous example, an end section 75 passes through the passage opening 21 in the housing part 3 and rests against the inner race 49 of the ball bearing 35. The channel 73 in the connection body 92 has a branch coaxial with the axis 91, having a female thread 93 to which a threaded ring 94 is screwed, to which in turn, the hollow body 72 of the quick coupling 85 is screwed.

1. A connection device, in particular for implementing a rotary connection for a connection component (71, 89), with a housing (1) having a connection point (7) for a fluid-conveying line, such as a pneumatic line, and a bearing arrangement (31), by means of which a shaft or axle-shaped connector part (24) is mounted such that it can rotate relative to the housing (1), which connector part has a further connection point (27) for the relevant connection component (71, 89), characterized in that the bearing arrangement (31) has at least one roller bearing (35), the outer side of the outer race (55) of which is in contact with the housing (1) and the outer side of the inner race (49) of which is in contact with the rotatable connector part (24).

2. The connection device according to claim 1, characterized in that the bearing arrangement (31) next to the roller bearing (35) has a slide bearing (43), which comprises the rotatable connector part (24) at the inner peripheral side and the end face of which rests against a press-fit ring (61) of the housing (1), which ring supports the end (67) of the connector part (24) while maintaining a radial and an axial spacing, and that the slide bearing (43) is otherwise mounted in a spacer ring (45).

3. The connection device according to claim 1, characterized in that a roller bearing in the form of a ball bearing (35) is provided.

4. The connection device according to claim 1, characterized in that the spacer ring (45) with the slide bearing (43) is radially sealed towards the housing (1), in particular using an O-ring (41), and rests against a further seal in the axial direction, in particular in the form of a shaft seal (39), which encompasses the connecting part (24) and which has a contact surface for a spacing ring (37) opposite from the spacer ring (45), which engages with the outer race (55) of the ball bearing (35) at the end face thereof.

5. The connection device according to claim 1, characterized in that the spacing ring (37) is angular viewed in cross-section, that one of its legs (51) abuts a shoulder (53) of the housing (1) and is in contact with the further seal (39) in the area of its second leg (57) and has an axial distance to a radially protruding bearing shoulder (47) of the connector part (24) opposite from the seal, with which shoulder the connector part (24) rests against the inner race (49) of the roller bearing (35) at the end face.

6. The connection device according to claim 1, characterized in that the housing (1) is made of two parts and one housing part (5) has the bearing arrangement (31) and the other housing part (3) has the associated connection point (7) and that the slide bearing (43) of the press-fit ring (61) at least partially rests against on the spacer ring (45) in the area (15) of the connection of the two housing parts (3, 5).

7. Connection device according to claim 1, characterized in that the connection point (27) of a rotatably mounted connector part (24), which is fixed in the housing (1) by means of the bearing arrangement (31), protrudes from the housing (1) in the axial direction, and that at the location of the penetration of the connector part (24), a ring opening (21) is created between the housing (1) and the connector part (24), which serves the penetration of parts (75) of the connection component (71, 89), the end faces of which rest against the inner race (49) of the roller bearing (35) and which can be firmly attached to the connector part (24).

8. The connection device according to claim 1, characterized in that a further sealing ring (59) is arranged between the press-fit ring (61) and the further housing part (3), and also on the further housing part (3) in the area of the transition to the connection point (7) for the fluid-conveying line.

9. A connection arrangement comprising at least one connection device (1) according to claim 1 and a connection component (71, 89) coupled thereto, which is connected to the connection device in a fluid-conveying manner and movable relative to the connection device by means of the bearing arrangement (31) and the connector part (24) mounted rotatably to that extent, opposite the connection device (1).

10. The connection arrangement according to claim 9, characterized in that the housing design of the associated connection component (71, 89) is designed linearly or angularly and has a quick coupling (85) for supporting a further fluid-conveying line at its free end.
